(19) United States
(12) Patent Application Publication
(10) Pub. No.: US 2026/0275096 A1
(43) Pub. Date: Sep. 17, 2026

(54) TERPOLYMER OF METHYL METHACRYLATE, STYRENE AND ALPHA-METHYL STYRENE

(71) Applicant: INEOS STYROLUTION GROUP GMBH, Frankfurt am Main (DE)

(72) Inventors: Jarrett R. ROWLETT, Oswego, IL (US); Thomas W. Cochran, Wilmington, IL (US)

(21) Appl. No.: 19/161,984

(22) PCT Filed: Mar. 4, 2024
(86) PCT No.: PCT/EP2024/055547

§ 371 Date: Sep. 3, 2025

(30) Foreign Application Priority Data
Mar. 6, 2023 (EP) 23160264.0

(51) Int. Cl. C08L 25/14; C08F 212/08; C08F 220/14; C08L 33/12

(52) U.S. Cl. CPC C08L 25/14; C08F 212/08; C08F 220/14; C08L 33/12; C08F 2800/20

(57) ABSTRACT

The invention relates to a terpolymer comprising repeating units of the monomers methyl methacrylate, styrene, and alpha-methyl styrene, as well as a process for producing the terpolymer. The invention further relates to a thermoplastic terpolymer composition comprising the terpolymer and a thermoplastic molding composition comprising the terpolymer, as well as to the use of these compositions, e.g. for producing shaped bodies.

The present invention relates to a terpolymer comprising repeating units of the monomers methyl methacrylate, styrene, and alpha-methyl styrene, as well as a process for producing the terpolymer. The invention further relates to a thermoplastic terpolymer compositions comprising the terpolymer and a thermoplastic molding composition comprising the terpolymer, as well as to the use of these compositions, e.g. for producing shaped bodies.

Vinylaromatic copolymers such as poly(styrene-acrylonitrile) (SAN), poly(alpha-methyl styrene-acrylonitrile) (AMSAN) and poly(styrene-methyl methacrylate) (SMMA) as well as blends of vinylaromatic copolymers with other polymers (e.g. impact-modifying polymers) are well known and widely used in industry and science due to their versatile and tailorable property profile.

Clear transparent polymer materials are of importance for many technical applications. It is desirable to provide transparent packaging materials such as films (e.g. for food packaging) or plastics moldings (e.g. bottles, boxes), transparent parts of buildings (e.g. window panes, films, signboards), transparent parts of cars (e.g. panes, screens, exterior lamp cases), transparent parts of electronics (e.g. screen surfaces, cases, lamps), optical fibers or transparent parts of varnish, toys, sports equipment or medical and laboratory equipment.

Copolymers of styrene and methyl methacrylate (SMMA) which are known for years have excellent properties in regards to melt flow and UV stability, and also exhibit good optical properties such as high clarity and high transparency. However, for certain uses and applications, the heat resistance of SMMA copolymers is not sufficient. Copolymers of styrene and methyl methacrylate are known in the prior art, see e.g. WO 2015/118142.

Copolymers of alpha-methyl styrene and methyl methacrylate (AMSMMA) have also been described before. U.S. Pat. No. 4,171,699 discloses syringe barrels made of 50 to 60 wt.-% of alpha-methyl styrene (AMS) and 40 to 50 wt.-% methyl methacrylate (MMA) which are capable of being sterilizes at high temperatures without deformation. U.S. Pat. No. 3,135,723 discloses a process for copolymerizing AMS and MMA in the presence of organic peroxides.

There is a need in the industry, e.g. for automotive applications such as taillights, for thermoplastic polymers with high temperature stability in terms of heat deflection temperature and high transparency, which have good processability (e.g. melt flow). At the same time, it is desirable to increase the heat deflection temperature while the refractive index of the polymer only changes moderately. This allows to provide blends with further polymer components which are already used and widely accepted for SMMA applications and exhibit good optical properties such as transparency, clarity and low haze.

It has been found that these problems can be solved by a terpolymer of methyl methacrylate, styrene and alpha-methyl styrene.

The invention in particular relates to a thermoplastic terpolymer A comprising (or consisting of):
a-1:30 to 69 wt.-%, based on the terpolymer A, of methyl methacrylate,
a-2:30 to 69 wt.-%, based on the terpolymer A, of styrene, and
a-3:1 to 25 wt.-%, based on the terpolymer A, of alpha-methyl styrene;
wherein constituents a-1, a-2 and a-3 sum up to 100 wt.-% of the thermoplastic terpolymer A.

In a further aspect, the invention relates to a thermoplastic terpolymer composition T comprising:
A: 97 to 100 wt.-%, based on the thermoplastic terpolymer composition T, of at least one terpolymer A comprising repeating units of the following monomers:
   a-1:30 to 69 wt.-%, based on the terpolymer A, of methyl methacrylate,
   a-2:30 to 69 wt.-%, based on the terpolymer A, of styrene, and
   a-3:1 to 25 wt.-%, based on the terpolymer A, of alpha-methyl styrene, wherein constituents a-1, a-2 and a-3 sum up to 100 wt.-% of the thermoplastic terpolymer A; and
B1:0 to 3 wt.-%, based on the thermoplastic terpolymer composition T, of at least one additive B1;
wherein components A and B1 sum up to 100 wt.-% of the thermoplastic terpolymer composition T.

As can be seen, the thermoplastic terpolymer composition T may comprise or consist of the at least one terpolymer A, may comprise or consist of one terpolymer A and one additive B1, or may comprise at least one terpolymer A and at least one additive B1, e.g. one terpolymer A and two or more additives B1, or e.g. two or more terpolymers A and two or more additive B1.

While increasing the content of methyl methacrylate (MMA) in a styrene-methyl methacrylate (SMMA) copolymer would increase the glass transition temperature and the heat deflection temperature of the resulting copolymer, it was found that at the same time the refractive index of the copolymer would change dramatically.

In order to obtain copolymers which may be used in blends with other copolymers commonly used in SMMA polymer blends (e.g. block copolymers of styrene and butadiene as impact-modifying copolymers), a matching range of refractive index has to be met. Thus, the refractive index of the copolymer is preferably similar to known SMMA copolymers and needs to be in a close proximity of the refractive index of the further copolymer in order to result in blends of high transparency, high clarity and low haze. Such isorefractive polymer blends preferably have a refractive index in the range of from 1.52 to 1.56, often 1.54 to 1.56, for example in the range from 1.54 to 1.55 or in the range from 1.55 to 1.56.

Unless otherwise mentioned, the refractive indices disclosed herein are at 589.3 nm and 23° C. and determined analogously to ASTM C 1648-12 using the Metricon® system described therein. According to the invention, for the purpose of determining the refractive index, sample plaques of the terpolymer A (or terpolymer composition T or molding composition M or the shaped bodies S produced therefrom, respectively) are used having a thickness which allows the measuring instrument to detect the light passing through the sample plaques. For example, the refractive index may be determined on a plaque (e.g. preferably a compression molded plaque) having a thickness which light may pass through, e.g. a thickness of approximately 1.59 mm ( 1/16 inch). According to the invention, a thickness of a sample plaque of approximately 1.59 mm is to be understood as a thickness in the range of from 1.58 to 1.60 mm. These sample plaques may also be used for determining further optical properties, in particular light transmittance.

It was found that the terpolymer A according to the invention meets these requirements. Typically, the terpolymer A has a refractive index determined at 589.3 nm in the range of from 1.54 to 1.56, for example in the range from 1.54 to 1.55 or in the range from 1.55 to 1.56.

In preferred embodiments, the thermoplastic terpolymer composition T according to the invention consists of the components A, and optionally B1. In other words, the terpolymer A may be understood and used as terpolymer composition T. However, the terpolymer composition may, in one embodiment, in addition to the terpolymer A, comprise one or more additive(s) B1.

The thermoplastic terpolymer A and the thermoplastic terpolymer composition T according to the present invention are transparent or at least partially transparent. In particular, when the thermoplastic terpolymer A or the thermoplastic terpolymer composition T, respectively, are once heated above the glass transition temperature Tg, subsequently molded and finally cooled below the glass transition temperature Tg, the obtained molding is transparent or at least partly transparent. The Tg-value of thermoplastic terpolymer A and the thermoplastic terpolymer composition T can be determined by common methods such as differential scanning calorimetry (DSC) as described herein below.

As used throughout the present invention, the term “transparent” may be understood in the broadest sense as ability of letting light pass through.

Preferably, transparency means that the terpolymer A itself has high light transmittance, typically of more than 85% determined according to ASTM D1003 on a compression molded plaque having a thickness of approximately 1.59 mm ( 1/16 inch).

The invention also relates to a thermoplastic molding composition M and a process for the preparation of a thermoplastic molding composition M according to the invention. Another aspect of the invention is a process for the preparation of a shaped article S comprising a thermoplastic terpolymer A, a thermoplastic terpolymer composition T or a thermoplastic molding composition M according to the invention. A further aspect of the invention is a shaped article S comprising a thermoplastic terpolymer A, a thermoplastic terpolymer composition T or a thermoplastic molding composition M according to the invention. Furthermore, an aspect of the invention is the use of a thermoplastic terpolymer A, a thermoplastic terpolymer composition T or a thermoplastic molding composition M according to the invention and of shaped articles S comprising it for outdoor applications, in particular for applications in the construction and automotive sector.

### Terpolymer A

According to the invention, the terpolymer A comprises repeating units of the monomers methyl methacrylate, styrene, and alpha-methyl styrene. The content of alpha methyl styrene in the terpolymer A ranges from 1 to 25 wt.-%, based on the terpolymer A, and is preferably in the range of from 2 to 22 wt.-%, more preferably 5 to 20 wt.-%, provided that the total amount of repeating units of monomers a-1, a-2 and a-3 sums up to 100 wt.-% of terpolymer A. It has been found that the glass transition temperature Tg of the terpolymer A can be increased by increasing the amount of alpha-methyl styrene. The increased Tg corresponds to an increased heat deflection temperature of the terpolymer A. However, at the same time the refractive index of the terpolymer A decreases with increasing amount of alpha-methyl styrene. Furthermore, terpolymers having a content of more than 25 wt.-% of alpha-methyl styrene typically have a high viscosity and are therefore difficult to synthesize and process.

The term “terpolymer” as used herein for terpolymer A may be understood in the broadest sense as any polymer comprising three or more different types of monomers (i.e., a1: methyl methacrylate, a-2: styrene, and a-3: alpha-methyl styrene) covalently connected with another. The terms indicating that the terpolymer A comprises monomers or the polymer consists of monomers will be understood by those skilled in the art as meaning that the monomers in this context are monomeric moieties embedded into the terpolymer strand.

In a terpolymer A, the different types of monomer moieties may be either evenly and homogeneously distributed over the terpolymer (random terpolymer) or may be located at a defined area of the polymer strand(s), i.e. in a block (block terpolymer). As used herein, the term “block terpolymer” may be understood in the broadest sense as any terpolymer having a defined polymer structure. Preferably, the terpolymer A is a random terpolymer.

The terpolymer A according to the present invention may bear a linear, circular or branched structure. A circular structure is a terpolymer strand wherein both ends are connected with another. As used herein, the term “branched structure” may be understood in the broadest sense as any structure deviating from a plain linear or circular structure. Accordingly, in a polymer of branched structure, there is at least one monomer binding to three or more other monomer(s).

Preferably, the terpolymer A of the present invention is an essentially linear or circular terpolymer, more preferably an essentially linear terpolymer, in particular a linear random terpolymer.

As used herein, methyl methacrylate (MMA) (a-1) is understood in the broadest sense. Herein, the terms “methyl methacrylate”, “methyl methacrylate moiety”, “methyl methacrylate monomer”, “methyl methacrylate monomer moiety” and similar terms are understood interchangeably.

As used herein, styrene(S) (a-2) is understood in the broadest sense. Herein, the terms “styrene”, “styrene moiety”, “styrene monomer”, “styrene monomer moiety” and similar terms are understood interchangeably.

As used herein, alpha-methyl styrene (AMS) (a-3) is understood in the broadest sense. Herein, the terms “alpha-methyl styrene”, “alpha-methyl styrene moiety”, “alpha-methyl styrene monomer”, “alpha-methyl styrene monomer moiety” and similar terms are understood interchangeably.

Optionally, the terpolymer A according to the present invention may also contain one or more methacrylate derivative(s) other than MMA such as, e.g. ethyl methacrylate (EMA), butyl methacrylate (BMA) and 2-ethyl hexyl methacrylate (2-EHMA), and methacrylic acid.

Preferably, such methacrylate derivatives and methacrylic acid do constitute for not more than 10 wt.-% of the terpolymer A, more preferably not more than 5 wt.-% of the terpolymer, often not more than 2 wt.-% of the terpolymer. Particularly preferably, the terpolymer A does not contain any further methacrylate derivatives other than MMA or methacrylic acid. In particular, the terpolymer A does not contain any further methacrylate derivative other than MMA.

Optionally, the terpolymer A according to the present invention may also contain one or more styrene derivatives other than styrene and alpha-methylstyrene such as, e.g. alkylated styrene (e.g., alpha-ethylstyrene, 2-methylstyrene, 3-methylstyrene, 4-methylstyrene, 2-ethylstyrene, 3-ethylstyrene, 4-ethylstyrene, 2,3-dimethylstyrene, 2,4-dimethylstyrene, 2,5-dimethylstyrene, 2,6-dimethylstyrene,2,3-diethylstyrene, 2,4-diethylstyrene, 2,5-diethylstyrene, 2,6-diethylstyrene, 2-methyl-3-ethylstyrene,2-methyl-4-ethylstyrene, 2-methyl-5-ethylstyrene, 2-methyl-6-ethylstyrene, 3-methyl-2-ethylstyrene, 3-methyl-4-ethylstyrene, 3-methyl-5-ethylstyrene, 3-methyl-6-ethylstyrene,4-methyl-5-ethylstyrene, 4-methyl-6-ethylstyrene, 2-ethyl-3-methylstyrene, 2-ethyl-4-methylstyrene, 2-ethyl-5-methylstyrene, 2-ethyl-6-methylstyrene, 3-ethyl-4-methylstyrene, 3-ethyl-5-methylstyrene, 3-methyl-6-ethylstyrene, 4-ethyl-5-methyl-styrene, 4-ethyl-6-methylstyrene), halogenated styrene (e.g., e.g., 2-chloro-styrene, 3-chloro-styrene, 4-chloro-styrene, 2-fluoro-styrene, 3-fluoro-styrene, 4-fluoro-styrene, 2,3-di-chloro-styrene, 2,4-dichloro-styrene, 2,5-di-chloro-styrene, 2,6-di-chloro-styrene,2,3-di-fluoro-styrene, 2,4-difluoro-styrene, 2,5-di-fluoro-styrene, 2,6-di-fluoro-styrene, 2-chloro-3-fluoro-styrene, 2-chloro-4-fluoro-styrene, 2-chloro-5-fluoro-styrene, 2-chloro-6-fluoro-styrene, 3-chloro-2-fluoro-styrene, 3-chloro-4-fluoro-styrene, 3-chloro-5-fluoro-styrene, 3-chloro-6-fluorostyrene, 4-chloro-5-fluoro-styrene, 4-chloro-6-fluoro-styrene, 2-fluoro-3-chloro-styrene, 2-fluoro-4-chloro-styrene, 2-fluoro-5-chloro-styrene, 2-fluoro-6-chloro-styrene, 3-fluoro4-chloro-styrene, 3-fluoro-5-chloro-styrene, 3-chloro-6-fluoro-styrene, 4-fluoro-5-chlorostyrene, 4-fluoro-6-chloro-styrene) or hydroxystyrene styrene (e.g., 2-hydroxystyrene, 3-hydroxystyrene, 4-hydroxystyrene, 2,3-dihydroxystyrene, 2,4-dihydroxystyrene, 2,5-dihydroxystyrene, 2,6-dihydroxystyrene).

Preferably, such styrene derivatives other than styrene and alpha-methyl styrene do constitute for not more than 10 wt.-% of the terpolymer A, more preferably not more than 5 wt.-% of the terpolymer, often not more than 2 wt.-% of the terpolymer. Particularly preferably, the terpolymer A does not contain any further styrene derivative other than styrene and alpha-methyl styrene.

Optionally, the terpolymer A according to the present invention may also contain acrylonitrile as a comonomer. Preferably, such acrylonitrile does constitute for not more than 10 wt.-% of the terpolymer A, more preferably not more than 5 wt.-% of the terpolymer A, often not more than 2 wt.-% of the terpolymer A. Preferably, the terpolymer A does not contain acrylonitrile.

Optionally, the terpolymer A according to the present invention may also contain one or more cross-linking moiety/moieties such as, e.g., divinylbenzene, in its polymer strand.

Preferably, such cross-linking agents do constitute for not more than 10 wt.-% of the terpolymer A, more preferably not more than 5 wt.-% of the terpolymer A, often not more than 2 wt.-% of the terpolymer A. Preferably, the terpolymer A does not contain any cross-linking moieties.

The content of methyl methacrylate in the terpolymer A ranges from 30 to 69 wt.-%, based on the terpolymer A, and is preferably in the range of from 35 to 60 wt.-%, more preferably 40 to 55 wt.-%, provided that the total amount of repeating units of monomers a-1, a-2 and a-3 sums up to 100 wt.-% of terpolymer A. The methyl methacrylate is particularly relevant for the UV stability of the terpolymer A. If the content of methyl methacrylate is below 30 wt.-%, the UV stability of the terpolymer is typically insufficient for many applications. However, increasing the content of methyl methacrylate too much results in loss of the benefits of the styrenic monomers, such as deteriorated processability due to an increase in melt viscosity.

Accordingly, the content of styrene in the terpolymer A ranges from 30 to 69 wt.-%, based on the terpolymer A, and is preferably in the range of from 30 to 60 wt.-%, more preferably of from 32 to 50 wt.-%, provided that the total amount of repeating units of monomers a-1, a-2 and a-3 sums up to 100 wt.-% of terpolymer A. A styrene content within this range ensures good processability of the terpolymer.

It has been found that the terpolymer A according to the invention has a very balanced property profile with regards to mechanical properties and optical properties.

In one embodiment of the invention, the terpolymer A comprises repeating units of the following monomers:
a-1:35 to 65 wt.-%, preferably 40 to 55 wt.-%, based on the terpolymer A, of methyl methacrylate,
a-2:30 to 55 wt.-%, preferably 32 to 50 wt.-%, based on the terpolymer A, of styrene, and
a-3:3 to 22 wt.-%, preferably 5 to 20 wt.-%, based on the terpolymer A, of alpha-methyl styrene;
wherein components a-1, a-2 and a-3 sum up to 100 wt.-% of the terpolymer A.

As noted above, the terpolymer A according to the present invention may be a random polymer or a block polymer. In a preferred embodiment, the terpolymer A is a random terpolymer. As used herein, a random polymer is a terpolymer wherein the different types of monomer moieties (i.e., at least constituents (a-1), (a-2) and (a-3)) are essentially evenly and homogeneously distributed over the terpolymer.

Preferably, the terpolymer A does not comprise any further monomer moieties than MMA, styrene and alpha-methyl styrene.

The terpolymer A preferably has a glass transition temperature Tg determined by differential scanning calorimetry (DSC) with a heating rate of 10° C./min of more than 105° C., often of more than 110° C. For example, the terpolymer A preferably has a glass transition temperature Tg determined by differential scanning calorimetry (DSC) with a heating rate of 10° C./min in the range of from 105° C. to 125° C., often in the range of from 106° C. to 125° C. In some applications it desirable to have terpolymers A having a Tg above 110° C. in order to achieve a certain heat deflection temperature. As previously discussed, the

Tg may be increased by increasing the amount of alpha-methyl styrene in the terpolymer A. When determining the glass transition temperature Tg by differential scanning calorimetry (DSC) with a heating rate of 5° C./min, the Tg of terpolymer A is preferably in the range of from 105° C. to 125° C. and often above 110° C.

Process for the preparation of the terpolymer A

The terpolymer A may be produced in an analogous process to known processes for the production of copolymers of methyl methacrylate and styrene or methyl methacrylate and alpha-methyl styrene. Well-known conventional polymerization procedures for the preparation of SMMA may be adapted for the preparation terpolymer A according to the present invention. Terpolymer A is e.g. obtained in a known manner by bulk, solution, suspension, precipitation or emulsion polymerization. Details of these processes are described, for example, in Kunststoffhandbuch, ed. R. Vieweg and G. Daumiller, Vol. V “Polystyrol”, Carl-Hanser-Verlag Munich, 1969, p. 118 ff.

Exemplarily, the terpolymer A may be prepared by emulsion polymerization, solution polymerization or bulk polymerization. Preferably, heat or radical initiation may be used (including living polymerization methods).

Methyl methacrylate (MMA) monomers a-1, styrene monomers a-2 and alpha-methyl styrene monomers a-3 are commercially available. Others can be easily obtained by standard chemical processes known in the art.

In general, the terpolymer A of methyl methacrylate, styrene and alpha-methyl styrene is obtainable by a process of copolymerizing a monomer mixture comprising at least the following monomers:
a-1:30 to 69 wt.-%, preferably 35 to 65 wt.-%, more preferably 40 to 55 wt.-%, based on the reaction mixture, of methyl methacrylate,
a-2:20 to 69 wt.-%, preferably 23 to 55 wt.-%, more preferably 28 to 55 wt.-%, based on the reaction mixture, of styrene, and
a-3:1 to 35 wt.-%, preferably 2 to 30 wt.-%, more preferably 3 to 23 wt.-%, based on the reaction mixture, of alpha-methyl styrene;
wherein components a-1, a-2 and a-3 sum up to 100 wt.-% of the monomer mixture.

The monomer mixture may optionally be admixed with at least one organic solvent, polymerization initiator, and/or additive B1. The monomer mixture alone or in combination with solvent(s), polymerization initiator(s), and/or additive(s) is also referred to herein as reaction mixture.

Copolymerization for the preparation of terpolymer A may optionally be carried out in the presence of, e.g., one or more solvent(s) and/or one or more initiator(s) (e.g., one or more radical starter(s)) and/or one or more additive(s) B1. The reaction is often carried out in bulk or in solution. In industrial scale, the reaction is typically carried out in bulk, i.e. in the absence of a substantial amount of a solvent, for example in a continuous stirred-tank reactor (CSTR). However, in smaller scales, e.g. in laboratory scale, it is often required to add a solvent which allows for an easier stirring of the reaction mixture. The copolymerization reaction can be carried out similar to processes known in the art for the preparation of SMMA, for example as described in WO 2015/118142, page 20, line 23, to page 23, line 7, using reaction mixtures comprising the monomers according to the present invention.

Suitable solvents include all organic solvents, which are inert under reaction conditions and preferably have a boiling temperature at atmospheric pressure of at least 100° C., preferably at least 130° C. Examples of suitable solvents include toluene, xylene and ethylene benzene, in particular ethylene benzene.

At temperatures above 130° C., solvents are often not required and the polymerization reaction can be carried out in bulk.

In one embodiment, the terpolymer A may be prepared by mixing the methyl methacrylate, styrene and alpha-methyl styrene in the above-mentioned amounts in a reaction vessel and heating the reaction mixture, preferably under continuous stirring, to a temperature which allows the polymerization reaction to take please. The preferred reaction temperature at which the polymerization reaction takes place is typically in the range of from 100° C. to 200° C.

The initiation of copolymerization may e.g. be started by thermal decomposition of an initiator (e.g an (organic) peroxide initiator (e.g., dicumyl peroxide or benzoyl peroxide) or an azo compound), photolysis (e.g., with metal iodides, metal alkyls or azo compounds (e.g., azoisobutylnitrile (AIBN))), an initiator composition enabling a redox reaction (e.g., reduction of hydrogen peroxide or an alkyl hydrogen peroxide by means of iron ions or other reductants such as, e.g, Cr²⁺, V²⁺, Ti³⁺, Co²⁺ or Cu⁺), persulfate activation, ionizing radiation (e.g., by means of α-, β-, γ- or x-rays), electrochemical activation, plasma activation, sonication (e.g., at around 16 kHz) or a ternary Initiator (e.g., benzoyl peroxide3,6-bis(o-carboxybenzoyl)-N-isopropylcarbazole-di-η5-indenyl-zicronium dichloride optionally in combination with a metallocene (e.g., indenylzirconium) and/or a peroxide (e.g., benzoyl peroxide).

In a preferred embodiment, the copolymerization reaction process comprises heating of the reaction mixture comprising the monomers above a temperature above 100° C. and/or adding one or more polymerization initiator(s) to said reaction mixture.

The addition of polymerization initiators and/or polymerization catalysts allows for the reaction to start already at lower temperatures. In the presence of polymerization initiators and/or polymerization catalysts, often temperatures of from 100 to 160° C. are sufficient to initiate the copolymerization reaction.

The required reaction time depends on the reaction conditions (reaction scale, reaction temperature, addition and amount of polymerization aids and solvents) and the desired degrees of polymerization. The reaction progress can be monitored by known methods, e.g. by analyzing samples from the reaction mixture during the polymerization reaction.

The polymerization reaction time can be adjusted by the skilled worker based on these investigations.

The reaction mixture can be maintained or brought to conditions allowing chain elongation of the polymer. For instance, the temperature is set according to the monomer/terpolymer content of the reaction mixture. Exemplarily, the temperature may optionally also be varied during incubation, such as, e.g., constantly or stepwise increased during the polymerization process. Exemplarily, methods for producing SMMA copolymers which may be adapted to the preparation of the terpolymer A as used in the present invention may be conducted as shown in any of WO 2015/118142, GB 464688, GB 531956, GB 863279 and WO 2003/051973.

Thermoplastic terpolymer composition T

According to the invention, the thermoplastic terpolymer composition T comprises or consists of:
A: 97 to 100 wt.-%, preferably 98 to 99.9 wt.-%, based on the thermoplastic terpolymer composition T, of at least one terpolymer A according to the invention comprising repeating units of the following monomers:
   a-1:30 to 69 wt.-%, based on the terpolymer A, of methyl methacrylate,
   a-2 30 to 69 wt.-%, based on the terpolymer A, of styrene, and
   a-3:1 to 25 wt.-%, based on the terpolymer A, of alpha-methyl styrene,
   wherein components a-1, a-2 and a-3 sum up to 100 wt.-% of the terpolymer A; and
B1:0 to 3 wt.-%, preferably 0.1 to 2 wt.-%, based on the thermoplastic terpolymer composition T, of at least one additive B1;
wherein components A and B1 sum up to 100 wt.-% of the thermoplastic terpolymer composition T.

The terpolymer A is as defined herein above. Additives B1 are defined in the following.

Preferably, the thermoplastic terpolymer composition T has a refractive index determined at 589.3 nm in the range of from 1.54 to 1.56, for example in the range from 1.54 to 1.55 or in the range from 1.55 to 1.56.

Preferably, the thermoplastic terpolymer composition T has high light transmittance, typically of more than 85% determined according to ASTM D1003 on a compression molded plaque having a thickness of approximately 1.59 mm ( 1/16 inch).

In a preferred embodiment, the thermoplastic terpolymer composition T consists of component A and optionally component B1.

### Additives B

The thermoplastic compositions according to the invention (i.e. the thermoplastic terpolymer composition T and the thermoplastic molding composition M), may optionally comprise one or more additive(s) B. These additives B are referred to herein as additive B1 as regards the thermoplastic terpolymer composition T and additive B2 as regards the thermoplastic molding composition M, wherein the amounts of B1 and B2 sum up to the total amount of additive B. Additives B1 and B2 may be the same or different from each other. Both additives B1 and B2 may preferably be selected independently from the additives B described in the following.

The thermoplastic terpolymer composition T may optionally comprise up to 3.0 wt.-%, preferably 0.1 to 2 wt.-%, based on the terpolymer composition T of one or more additive(s) B including stabilizing additives and processing aids. The thermoplastic molding composition M may optionally comprise up to 5.0 wt.-%, preferably 0.1 to 2 wt.-%, based on the thermoplastic molding composition M, of one or more additive(s) B including stabilizing additives and processing aids.

Suitable additives B include all substances customarily employed for processing or finishing the polymers, except of fillers/fibers and pigments (see e.g. “Plastics Additives Handbook”, Hans Zweifel, 6th edition, Hanser Publ., Munich, 2009).

Preferred additives B are e.g. oxidation retarders, anti-oxidants, UV stabilizers agents to counter thermal decomposition, lubricants and dyes.

These additives B may be admixed at any stage of the manufacturing operation, but preferably at an early stage in order to profit early on from the stabilizing effects (or other specific effects) of the added substance.

Suitable antioxidants are, e.g., one or more compounds selected from mono-phosphitebased antioxidants, di-phosphite-based antioxidants and sterically hindered phenolic antioxidants. If one or more antioxidants are present, they are preferably selected from mono-phosphite-based antioxidants, such as tri-substituted mono-phosphite derivatives, di-phosphite-based antioxidants, such as substituted pentaerythritol di-phosphite derivatives and sterically hindered phenolic antioxidants, such as 2,6-di-tertbutylphenolic derivatives.

Examples of suitable UV-stabilizers are various substituted resorcinols, salicylates, benzophenones, benzotriazoles, triazines and HALS (hindered amine light stabilizers), for example those commercially available as Tinuvin®, which are generally used in amounts of up to 1.7 wt.-%, based on the terpolymer composition T or the thermoplastic molding composition M, respectively.

Suitable lubricants/glidants and demolding agents include stearic acids, stearyl alcohol, stearic esters, amide waxes (bis-stearylamide, in particular ethylene bis-stearamide), polyolefin waxes having a weight average molecular weight of ≤20,000 g/mol and/or generally higher fatty acids, derivatives thereof and corresponding fatty acid mixtures comprising 12 to 30 carbon atoms. The polyolefin waxes are typically present in an amount of less than 1 wt.-% based on the terpolymer composition T or the thermoplastic molding composition M, respectively.

Suitable dyes are any of the dyes which can be used for the transparent, semitransparent, or non-transparent coloring of polymers, in particular those dyes which are suitable for coloring styrene copolymers. Dyes of this type are known to the skilled worker. Preferred are dyes which can be used for the transparent coloring of polymers.

Examples of oxidation retarders and heat stabilizers are halides of the metals from group I of the periodic table, examples being sodium, potassium and/or lithium halides, optionally in combination with copper (I) halides, e.g., chlorides, bromides, iodides, sterically hindered phenols, hydroquinones, different substituted representatives of these groups, and mixtures thereof, in concentrations of up to 1 wt.-%, based on the weight of the terpolymer composition T or the thermoplastic molding composition M, respectively.

Process for the preparation of the terpolymer composition T

The thermoplastic terpolymer composition T according to the invention may be prepared by mixing terpolymer A with optional additive(s) B1. If multiple additives B1 are used, these can be added to terpolymer A by separate addition, or by addition of a mixture. Preferably, terpolymer A is provided in a molten state and additive B1 are added to a melt of terpolymer A. The mixing of the components can be performed by suitable means such as e.g. a mixer, a kneader or an extruder, preferably a twin screw extruder. The melt-mixing may be performed, preferably in an extruder, at temperatures in the range of from 160 to 260° C. Preferably, melt-mixing is performed in an extruder at temperatures in the range of from 180 to 230° C.

Alternatively, the additive(s) B1 may be introduced to the terpolymer A already during or immediately after the polymerization reaction. For example, antioxidants, if present, are preferably introduced into the reactor during the polymerization of terpolymer A. This allows to protect the terpolymer A from oxidation immediately after its preparation.

Thermoplastic molding composition M

A further aspect of the invention is a thermoplastic molding composition M, comprising:
T: 40 to 99 wt.-%, based on the molding composition M, of at least one terpolymer composition T according to the invention comprising at least one terpolymer A according to the invention,
C: 1 to 60 wt.-%, based on the molding composition M, of at least one polymer compound C, wherein the at least one polymer compound C is a thermoplastic homopolymer and/or copolymer different from terpolymer A, and
B2:0 to 5 wt.-%, based on the molding composition M, of at least one additive B2; wherein components T, C and B2 sum up to 100 wt.-% of the thermoplastic molding composition M.

The molding composition M comprises 40 to 99 wt.-%, preferably 50 to 90 wt.-%, based on the total molding composition M, of the terpolymer composition T described herein above. As previously mentioned, the terpolymer composition T comprises at least one terpolymer A and optionally at least one additive B1. Thus, the terpolymer composition T may consist of the at least one terpolymer A, may consist of two or more terpolymers A or may comprise or consist of at least one (i.e. one or more) terpolymer A and at least one additive B1.

The molding composition M further comprises 1 to 60 wt.-%, preferably 10 to 50 wt.-%, based on the total molding composition M, of at least one polymer compound C, wherein the at least one polymer compound C is a thermoplastic homopolymer and/or copolymer different from terpolymer A.

The polymer compound C is typically added to improve the properties of the molding composition with regards to mechanical properties such as impact strength and melt flow properties.

Suitable polymer compounds C generally include thermoplastic homo- and copolymers, which are miscible with the terpolymer A. However, in order to provide thermoplastic molding compositions M with high transparency and clarity, the polymer compound(s) C preferably have a refractive index (at 589.3 nm) in the range of from 1.52 to 1.57, preferably in the range of from 1.54 to 1.56, for example in the range from 1.54 to 1.55 or in the range from 1.55 to 1.56.

Preferably, the polymer compounds C are selected from homo- and copolymers monomers selected from styrene, alpha-methyl styrene, acrylonitrile, butadiene, and butylacrylate. Suitable polymer compounds C include poly(styrene-methyl methacrylate) (SMMA), poly(styrene-acrylonitrile) (SAN), poly(alpha-methyl styrene-acrylonitrile) (AMSAN), poly(butadiene), graft copolymers of acrylonitrile, butadiene and styrene (ABS), graft copolymers of acrylonitrile, butylacrylate and styrene (ASA), block copolymers of styrene and butadiene (SB), hydrogenated block copolymers of styrene and butadiene (SEBS) and mixtures thereof. Preferably, the polymer compound C is selected from poly(styrene-methyl methacrylate) (SMMA), graft copolymers of acrylonitrile, butadiene and styrene (ABS), block copolymers of styrene and butadiene (SB), hydrogenated block copolymers of styrene and butadiene (SEBS), more preferably selected from block copolymers of styrene and butadiene (SB), and hydrogenated block copolymers of styrene and butadiene (SEBS) and mixtures thereof. In one embodiment, polymer compound C comprises at least one block copolymer of styrene and butadiene (SB). In an alternative embodiment, polymer compound C comprises at least one hydrogenated block copolymers of styrene and butadiene (SEBS). In a further alternative embodiment, polymer compound C comprises at least one poly(styrene-methyl methacrylate) (SMMA).

The thermoplastic molding composition M may further comprise 0 to 5 wt.-% of at least one additive component B2. The additive component B2 may be selected from the additives B described herein, wherein the amounts disclosed for the additives B, generally apply for additives B1, additives B2, or the total amount of additives B1 and B2, based on the molding composition M.

Thus, in a preferred embodiment, if the terpolymer composition T used in the molding composition M already comprises additives B1, the amount of additive B2 is adjusted in order to assure that the total content of additive(s) B (i.e. the sum of additives B1+B2) is in the range of from 0 to 5 wt.-%, preferably in the range of from 0.1 to 2 wt.-%, based on the molding composition M. For example, additive B1 may be selected from antioxidants and be admixed with the terpolymer A to form the thermoplastic terpolymer composition T, whereas additive B2 may be selected from processing aids or dyes and be admixed with said thermoplastic terpolymer composition T and at least one polymer component C to form the thermoplastic molding composition M.

In preferred embodiments, the thermoplastic molding composition M according to the invention consists of the components T, C, and optionally B2.

Preferably, the thermoplastic molding composition M has a refractive index determined at 589.3 nm in the range of from 1.54 to 1.56, for example in the range from 1.54 to 1.55 or in the range from 1.55 to 1.56.

Preferably, the thermoplastic molding composition M has high light transmittance, typically of more than 85% determined according to ASTM D1003 on a compression molded plaque having a thickness of approximately 1.59 mm ( 1/16 inch).

Process for the preparation of the molding composition M

A further aspect of the invention is a process for the preparation of a molding composition M according to the invention. The process includes mixing of the terpolymer composition T (or the terpolymer A) with one or more polymer compound(s) C and—if present—with one or more additives B2. If multiple additives B2 are used, these can be added to terpolymer A by separate addition, or by addition of a mixture. Preferably, in the process according to the invention, the terpolymer composition T (or the terpolymer A) and the polymer compound(s) C are provided in a molten state and—if present—additive(s) B2 are added to the melt of the terpolymer composition T (or the terpolymer A) and/or the polymer compound(s) C. Preferably the melt-mixing of the components T, C and, if appropriate, component B2 is performed in an extruder, preferably a twin screw extruder.

The components T, C, and B2 are as defined herein.

The melt-mixing may be performed, preferably in an extruder, at temperatures in the range of from 160 to 260° C. Preferably, melt-mixing is performed in an extruder at temperatures in the range of from 180 to 230° C.

The molding composition M obtained by said process shows a good processability and thus can be easily processed, i.e. molded to any desired shape e.g. by extrusion and hot molding (e.g. injection molding). Accordingly, a further aspect of the invention is a shaped article S produced from the molding composition M according to the invention.

### Shaped Article S

The thermoplastic molding composition M, the thermoplastic terpolymer composition T and the terpolymer A, respectively, according to the present invention may be used to produce a shaped article S therefrom.

Thus, a further aspect of the invention is a process for the preparation of a shaped article S comprising the thermoplastic molding composition M, the thermoplastic terpolymer composition T and/or the terpolymer A, respectively, according to the invention wherein the shaped article S is formed by extrusion, injection molding, casting, blow molding, spraying, spinning, rolling, weaving, forming a suspension from an emulsion etc. or a combination of two or more thereof, in particular extrusion or injection molding.

In this context, the person skilled in the art will know several means for producing one or more of such shaped articles S from the thermoplastic molding composition M, the themoplastic terpolymer composition T and/or the terpolymer A, respectively. Producing a shaped article S may, e.g., be performed by extrusion, injection molding, casting, blow molding, spraying, spinning, rolling, weaving, forming a suspension from an emulsion etc. or a combination of two or more thereof. The person skilled in the art will know which method(s) to apply for producing the respective shaped article S, depending to the desired shape.

The person skilled in the art will also notice that a shaped article S in the sense of the present invention may be obtained from thermoplastic molding composition M, the themoplastic terpolymer composition T and the terpolymer A, respectively, according to the present invention, which may either be a melt or present as a raw material for molding processes (e.g. in the form of pellets, powder and/or blocks) or may be dissolved in a suitable solvent.

Accordingly, a further aspect of the present invention relates to a shaped article S comprising (or consisting of) a thermoplastic molding composition M, a thermoplastic terpolymer composition T or a terpolymer A according to the present invention, respectively.

Preferably, the shaped article S has a refractive index determined at 589.3 nm in the range of from 1.54 to 1.56, for example in the range from 1.54 to 1.55 or in the range from 1.55 to 1.56.

Preferably, the shaped article S has high light transmittance, typically of more than 85% determined according to ASTM D1003 on a compression molded plaque having a thickness of approximately 1.59 mm ( 1/16 inch).

Accordingly, a further aspect of the invention is the use of thermoplastic molding composition M, a thermoplastic terpolymer composition T and/or a terpolymer A according to the invention and of shaped articles S comprising these for outdoor applications, preferably for applications in the construction and automotive sector, in particular for exterior automotive parts, such as e.g. exterior rear combination lamps.

The examples, FIGURES and the patent claims further illustrate the invention.

### Examples

### Test Methods:

Refractive index at 589.3 nm and 23° C. was determined analogously to ASTM C 1648-12 using a Metricon® Model 2010/M Prism Coupler (particular reference is made to section 9.4 of ASTM C 1648-12).

Optical properties (transmittance) were determined in accordance with ASTM D1003 on compression-molded plaques having a thickness of approximately 1.59 mm (0.0625 inch/ 1/16 inch).

Glass transition temperature was determined by differential scanning calorimetry (DSC) in nitrogen in a temperature range of from −50° C. to 200° C. with two different heating rates of 5° C./min and 10° C./min, respectively.

Weight-average molecular weight Mw, number-average molecular weight Mn and centrifuge-average molecular weight Mz of the terpolymer A was measured using SEC/GPC according to common laboratory methods.

The composition of the terpolymer A was determined by quantitative ¹H NMR spectroscopy using deuterated chloroform (CDCl₃) as solvent.

### Preparation of Terpolymer A

Methyl methacrylate, styrene and alpha-methyl styrene are placed in a round bottom flask in the ratios needed to obtain the intended composition of the terpolymer (or copolymer for the comparative examples). The monomers are then mixed with ethylene benzene. The obtained reaction mixture is heated to 130° C. to initiate the polymerization reaction and allowed to progress for roughly 4 hours under stirring (approximately 20% conversion of the monomers). A reflux condenser is used to control temperature and to ensure that no monomers are lost. A thermocouple is used to regulate temperature. Lastly, a balloon is placed onto the top of the reflux condenser to ensure a closed system and no monomer loss from the reaction. Air environment is used for the reaction.

4 hours after the reaction starts, a visible change in viscosity occurs. The reaction mixtures are then allowed to cool down overnight. Reaction solution is then precipitated in methanol to form a white sticking and viscous precipitate. This viscous white precipitate is re-dissolved in tetrahydrofurane (THF) and precipitated into methanol to form a white fibrous powder. The precipitate is isolated by filtration, washed with water, and dried in the vacuum oven at 200° C. twice overnight. Furthermore, before DSC measurement, the samples were dried an additional two hours at 200° C. in a vacuum oven.

The compositions of the obtained co- and terpolymers as well as their properties are presented in Table 1.

As can be seen from the comparison of Ex. 1 and Comp. Ex. 1, the incorporation of alpha-methyl styrene into a copolymer of methyl methacrylate and styrene results in a significant increase in glass transition temperature Tg. The Tg further increases with increasing amounts of alpha-methyl styrene and decreasing amounts of styrene (cf. Ex. 2 to 4). However, at the same time a decrease in refractive index is observed (cf. Comp. Ex 1 and Ex. 1 to 4). All examples Ex. 1 to Ex. 4 exhibit good light transmittance of more than 85% and have reasonable molecular weights.

As can be seen from Comp. Ex. 2 and 3, copolymers of styrene and alpha-methyl styrene (i.e. without methyl methacrylate) show only a smaller increase in glass transition temperature compared to the inventive terpolymers (cf. Ex. 4 and Comp. Ex. 3), but exhibit a drastic increase in refractive index.

Comparable results are obtainable for terpolymers prepared in bulk polymerization.

By blending the terpolymers with block copolymers of styrene and butadiene thermoplastic impact-modified terpolymer blends are obtainable which exhibit good optical and mechanical properties, among others, and can advantageously be used in molding processes.

The terpolymer composition as well as the molding composition according to the invention are advantageously used for the preparation of shaped articles, such as for outdoor applications, preferably for the construction and automotive sector.

TABLE 1
Formulations and properties of synthesized terpolymers (Examples 1 to 4 and Comparative Examples 1 to 3)

| | | | | | | | |
|---|---|---|---|---|---|---|---|
| | Comp. | | | | | Comp. | Comp. |
| Units | Ex. 1 | Ex. 1 | Ex. 2 | Ex. 3 | Ex. 4 | Ex. 2 | Ex. 3 |

Composition of the obtained polymer determined via NMR

| | | | | | | | | |
|---|---|---|---|---|---|---|---|---|
| styrene | wt.-% | 57.0 | 48.0 | 43.0 | 36.0 | 36.0 | 96.0 | 83.0 |
| methyl methacrylate | wt.-% | 43.0 | 44.0 | 46.0 | 46.0 | 50.0 | 0.0 | 0.0 |
| alpha-methyl styrene | wt.-% | 0.0 | 8.0 | 11.0 | 18.0 | 15.0 | 4.0 | 17.0 |

Properties

| | | | | | | | | |
|---|---|---|---|---|---|---|---|---|
| Mn | kg/mol | 74.9 | 78.3 | 70.8 | 63.4 | 61.3 | 54.5 | 41.5 |
| Mw | kg/mol | 118.6 | 116.0 | 105.2 | 90.3 | 84.1 | 89.8 | 66.3 |
| Mz | kg/mol | 167.7 | 162.4 | 143.8 | 120.9 | 110.2 | 127.1 | 92.7 |
| Tg via DSC (10° C./min) | ° C. | 104.6 | 108.1 | 111.6 | 115.2 | 118.3 | 106.4 | 110.7 |
| Tg via DSC (5° C./min) | ° C. | 103.9 | 106.7 | 109.8 | 113.4 | 117.2 | 104.9 | 108.9 |
| Refractive Index | | 1.5493 | 1.5476 | 1.5463 | 1.5457 | 1.5439 | 1.5897 | 1.5900 |
| Transmittance | % | 90.9 | 89.3 | 87.5 | 90.0 | 86.8 | 90.4 | 89.6 |

1-15. (canceled)

16. A thermoplastic molding composition M, comprising:
A: 40 to 99 wt.-%, based on the molding composition M, of at least one thermoplastic terpolymer A comprising repeating units of the following monomers:
a-1:30 to 69 wt.-%, based on the terpolymer A, of methyl methacrylate,
a-2:30 to 69 wt.-%, based on the terpolymer A, of styrene, and
a-3:1 to 25 wt.-%, based on the terpolymer A, of alpha-methyl styrene,
wherein components a-1, a-2 and a-3 sum up to 100 wt.-% of the thermoplastic terpolymer A, and
wherein the thermoplastic terpolymer A has a refractive index at 589.3 nm in the range of from 1.54 to 1.56;
B: 0 to 5 wt.-%, based on the molding composition M, of at least one additive B;
C: 1 to 60 wt.-%, based on the molding composition M, of at least one polymer compound C, wherein the at least one polymer compound C is a thermoplastic homopolymer and/or copolymer different from the thermoplastic terpolymer A; and
wherein the polymer compound C has a refractive index at 589.3 nm in the range of from 1.52 to 1.57,
wherein components A, B, and C sum up to 100 wt.-% of the thermoplastic molding composition M.

17. The thermoplastic molding composition M according to claim 16, wherein the thermoplastic molding composition M has a refractive index at 589.3 nm in the range of from 1.54 to 1.56, and a light transmittance of more than 85% determined according to ASTM D1003.

18. The thermoplastic molding composition M according to claim 16, wherein the thermoplastic terpolymer A comprises 2 to 22 wt.-% of alpha methyl styrene.

19. The thermoplastic molding composition M according to claim 16, wherein the thermoplastic terpolymer A has a light transmittance of more than 85% determined according to ASTM D1003.

20. The thermoplastic molding composition M according to claim 16, wherein the thermoplastic terpolymer A comprises repeating units of the following monomers:
a-1:35 to 65 wt.-%, based on the terpolymer A, of methyl methacrylate,
a-2:30 to 55 wt.-%, based on the terpolymer A, of styrene, and
a-3:5 to 20 wt.-%, based on the terpolymer A, of alpha-methyl styrene,
wherein components a-1, a-2 and a-3 sum up to 100 wt.-% of the thermoplastic terpolymer A.

21. The thermoplastic molding composition M according to claim 16, wherein the thermoplastic terpolymer A has a glass transition temperature Tg, determined by differential scanning calorimetry (DSC) with a heating rate of 10° C./min, in the range of from 105° C. to 125° C.

22. The thermoplastic molding composition M according to claim 16, wherein the thermoplastic terpolymer A has a refractive index at 589.3 nm in the range of from 1.54 to 1.56 and a light transmittance of more than 85% determined according to ASTM D1003.

23. A process for the preparation of a thermoplastic molding composition M according to claim 16, wherein the process includes:
(i) producing a thermoplastic terpolymer A of methyl methacrylate, styrene and alpha-methyl styrene;
(ii) optionally mixing thermoplastic terpolymer A with one or more additive(s) B1 to obtain a thermoplastic terpolymer composition T; and
(iii) mixing of the thermoplastic terpolymer composition T obtained in step (ii) or the thermoplastic terpolymer A obtained in step (i) with one or more polymer compound(s) C and optionally with one or more additive(s) B2.

24. The process according to claim 23, wherein the process for producing the thermoplastic terpolymer A of methyl methacrylate, styrene, and alpha-methyl styrene comprises polymerizing a monomer mixture comprising:
a-1:30 to 69 wt.-%, based on the reaction mixture, of methyl methacrylate,
a-2:20 to 69 wt.-%, based on the reaction mixture, of styrene, and
a-3:1 to 35 wt.-%, based on the reaction mixture, of alpha-methyl styrene; and
wherein components a-1, a-2 and a-3 sum up to 100 wt.-% of the monomer mixture.

25. The process according to claim 24, wherein the polymerization reaction takes place at temperatures of 100° C. to 200° C.

26. The shaped article S comprising at least one thermoplastic molding composition M according to claim 16.

27. The shaped article S according to claim 26, wherein the shaped article S has a refractive index at 589.3 nm in the range of from 1.54 to 1.56, and a light transmittance of more than 85% determined according to ASTM D1003.

28. The process according to claim 23, wherein the process for producing the thermoplastic terpolymer A of methyl methacrylate, styrene and alpha-methyl styrene comprises polymerizing a monomer mixture comprising:
a-1:35 to 65 wt.-%, based on the reaction mixture, of methyl methacrylate,
a-2:23 to 55 wt.-%, based on the reaction mixture, of styrene, and
a-3:2 to 30 wt.-%, based on the reaction mixture, of alpha-methyl styrene; and
wherein components a-1, a-2 and a-3 sum up to 100 wt.-% of the monomer mixture.

29. The process according to claim 24, wherein the process for producing the thermoplastic terpolymer A of methyl methacrylate, styrene and alpha-methyl styrene comprises polymerizing a monomer mixture comprising:
a-1:40 to 55 wt.-%, based on the reaction mixture, of methyl methacrylate,
a-2:28 to 55 wt.-%, based on the reaction mixture, of styrene, and
a-3:3 to 23 wt.-%, based on the reaction mixture, of alpha-methyl styrene; and
wherein components a-1, a-2 and a-3 sum up to 100 wt.-% of the monomer mixture.

30. The thermoplastic molding composition M according to claim 16, wherein the thermoplastic terpolymer A comprises 5 to 20 wt.-% of alpha methyl styrene.
